(19) United States
(12) Patent Application Publication
(10) Pub. No.: US 2005/0086725 A1
(43) Pub. Date: Apr. 28, 2005

(54) Apparatus for putting a loading object in mouth by motion of jaw

(76) Inventor: Sunnsuke Kameya, Sapporo (JP)

Correspondence Address: Sunnsuke Kameya;Tyuouku Minami 20 Jo Nish 14, Tyome 3-17 Coopo 20 Joy C-7, Sapporo, Hokkaido, 064-0920, JP

(21) Appl. No.: 10/956,992

(22) Filed: Oct. 4, 2004

(30) Foreign Application Priority Data
Oct. 2, 2003 (JP) JP2003-379138
Sep. 24, 1983 (JP) JP-S58-176747

(51) Int. Cl. A61C 8/00

(52) U.S. Cl. 2/209.13

(57) ABSTRACT

A loading object putting apparatus (a, b, c, d, and e) puts a loading object (e) in mouth by movement of jaw. The loading object putting apparatus (a, b, c, d, e) includes a headgear (a), an arm connecting means (b), an arm (c), a lever apparatus (d) rocked by a jaw, and the loading object (e).

### FEDERALLY SPONSORED RESERCH

Not Applicable

### SEQUENCE LISTING OR PROGRAM

Not Applicable

### BACKGROUND OF THE INVENTION—FIELD OF INVENTION

This invention relates to an apparatus for putting a Loading object in mouth by motion of lower jaw without using hands.

### BACKGROUND OF THE INVENTION—PRIOR ART

In order to make it easy to use, the whistle has been used by the way of hanging on head though strap.

However, there are the billowing problems by this general way.

(a) Finding the whistle is hard, so it takes some time to blow the whistle.

(b) The whistle cannot be used if hands are not free.

U.S. Pat No. 5,504,943 describes a headgear having an attachable whistle. This conventional technology be able to blow whistle quickly, but that the technology has a problems of actual use.

(a) The whistle can not be adjusted, if hand is not free.

(b) Without electric power, loud sound can't be made.

In general art, stick put in the mouth has been used for operation of electric equipments by persons having trouble with hand.

There are the problems by this general way as following.

(a) It is hard for the persons to put stick in mouth.

(b) It is hard for the persons to put stick in mouth.

(c) When the persons interrupt the work for a second or talking, the stick must be put out from mouth.

### BACKGROUND OF INVENTION—OBJECTS

Therefore, an object of this invention is to provide an apparatus for solve a following problems.

(a) To provide an apparatus for putting an object in mouth quickly without using hand when need, and when no need the object which is put out from mouth automatically.

(b) To provide an apparatus which capable of using without power.

(c) To provide an apparatus which does not become interruption of other work.

(d) To provide the apparatus which can also use as an option operation of the easy electronic equipment this uses electricity.

### SUMMARY

This invention relates to an apparatus for putting a loading object in mouth by movement of jaw comprising a headgear, an arm having a means for adjusting the arm length and a means for bending the arm and a means for connecting one end of the arm to the headgear side wall and a lever apparatus connecting to the other end of the arm, the lever apparatus having a fulcrum member and a link member connecting the fulcrum and a jaw receptacle holder on the one end of the link member, and a loading object adjustment device on the other end of the link member, a loading object being connected on the loading object adjustment device, whereby the loading object adjustment device adjusts the status of the loading object relating to mouth of user, and characterized by having a means for swingablly connecting the lever apparatus to the other end of the arm by movement of jaw in contact with the jaw receptacle holder.

### DRAWINGS—FIGURES

FIG. 1 is a side view of the putting apparatus being used by user.

FIG. 2 is an overall perspective view of the putting apparatus.

FIG. 3 is an overall perspective view showing moving direction of the putting apparatus's moving parts by the arrows.

FIG. 4 is a perspective view of a folded up the arm and the lever apparatus after separating from the arm connecting means on the side of the headgear.

FIG. 5 is a partial detailed perspective view of the lever parts and the end of the arm shown in FIG. 2.

FIG. 6 is a partial detailed perspective view of near the fulcrum member of the lever.

FIG. 7 is the exploded perspective view of the putting apparatus.

FIG. 8 is a longitudinal sectional view of the arm connecting means.

FIG. 9 is a perspective view of the embodiment 2 of the lever apparatus.

FIG. 10 is the exploded perspective view of the hard hat and the arm connecting means.

FIG. 11 is a perspective view of the other embodiment of the putting apparatus.

FIG. 12 is a perspective view which connected the putting apparatus to the head band.

### DETAILED DESCRIPTION

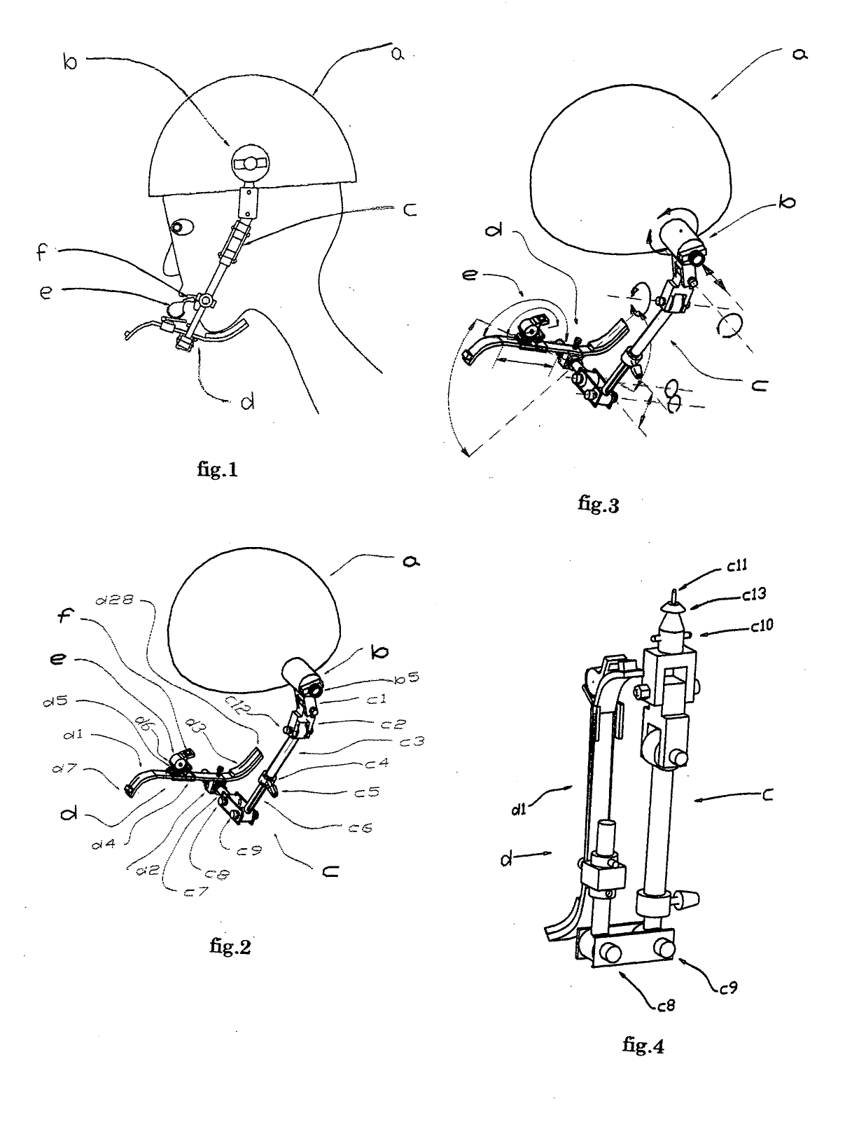

In accordance with the present invention, a loading object putting apparatus (a, b, C, d, e) puts a loading object in mouth by movement of jaw. FIG. 1 is a side view of the loading object putting apparatus (a, b, c, d, e) being used by user. In this FIG. 1, a user supplies the Loading object (e) to a mouth by the Lever apparatus (d) swung by motion of jaw.

FIG. 2 is a perspective view of the loading object putting apparatus (a, b, c, d, e). The putting apparatus has a hard hat (a), an arm connection means (b), an arm (c), lever apparatus (d), the loading object (e), and a primary detecting element (f).

FIG. 3 shows the motion of the moving part of FIG. 2 by the arrow. The arm connecting means (b) is attached on the side wall of the hard hat (a). The arm connecting means (b) contains the knob (b5). The knob (b5) moves in the direction of the arrow shown in FIG. 3, and makes the arm (c) a detachable attachment easily.

The arm (c) has attached the lever apparatus (d) at the tip. The arm (c) contains a means for bending the arm and means for adjusting the arm length, in order to adjust the position of the lever apparatus (d). The means or bending the arm has a first joint (c1, c2) and a second joint (c8, c9).

The means for adjusting the arm length has a slide outer rod (c3), a ring (c4), a slide lock screw (c5), and a slide rod (c6). The slide rod (c6) carries out slide movement in the up-and-down direction. The slide outer rod (c3) stores the slide rod (c6). The slide lock screw (c5) fixes the slide rod (c6). The slide rod (c6) has the slot the way of a straight side into which the slide lock screw (c5) fits was trenched. Thereby, the slide rod (c6) does not rotate. The ring (c4) is attached at the slide outer rod (c3). The ring (c4) has a screw hole. Therefore, the slide lock screw (c5) fits in.

The lever apparatus (d) contains a fulcrum member (d2), a link member (d1), a jaw receptacle holder (d3), jaw receptacle holder putt (d28), a loading object adjustment means (d4.d5), a loading object holder (d6), weight (d7), and the loading object (e) and a primary detecting element (f). The fulcrum member (d2) is connected to the arm tip stick (d7) possible [a swing]. The link member (d1) is made from the long member. The link member (d1) is connected on the fulcrum member (d2). The link member (d1) has the jaw receptacle holder (d3) in the loading object adjustment means (d4, d5) and the other end at the tip. The loading object adjustment means (d4, d5) has a means for reciprocating means (d4) and a means for adjusting an angle of the loading object (d5). The means for reciprocating means (d4) carries out slide reciprocating movement to the way of a straight side of the link member (d1). The means for adjusting an angle of the loading object (d5) is an apparatus for rocking and adjusting the angle to the month of the loading object (e). The means for adjusting an angle of the loading object (d5) is connected on the means for reciprocating means (d4). On the means for adjusting an angle of the loading object (d5), the loading object holder (d6) is connected. Since the loading object holder (d6) is made from the elastic material, it can pinch the loading object (e). Therefore, it is a detachable attachment about the loading object (e) easily. The angle of the loading object (e) can also be adjusted. The primary detecting element (f) is attached on the portion which touches the mouth of the user of the loading object (e). There is a jaw receptacle holder (d3) which touches a jaw in the other end of the link member (d1). The jaw receptacle holder (d3) has made from a part of the end of the link member (d1) curved upward. The jaw receptacle holder (d3) has the jaw putt (d29) made from a soft material in the portion which touches jaw. If a jaw moves, the jaw receptacle holder (d3) will move, the link member (d1) will move to the next, and then the loading object (e) will move, and the loading object (e) will be carried by the mouth. If a user opens a mouth, the loading object (e) will return to the original position. This translation is in weight (d7). The attachment position (d8) of the weight (d7) is made from a part of the other end of the link member (d1) curved downward. If FIG. 1 is seen, it will be easy to understand this translation. It is for using little weight efficiently.

FIG. 4 is a figure of the arm (c) folded up, after removed from the arm attaching means (b). The method of folding up bends the 2nd joint, and is rotating the link member (d1) about 90 degrees on the fulcrum member (d2). The apparatus made to rotate the link member (d1) is a means for rotating the link member, and the apparatus which locks up the link member (d1) is a means for locking the link member.

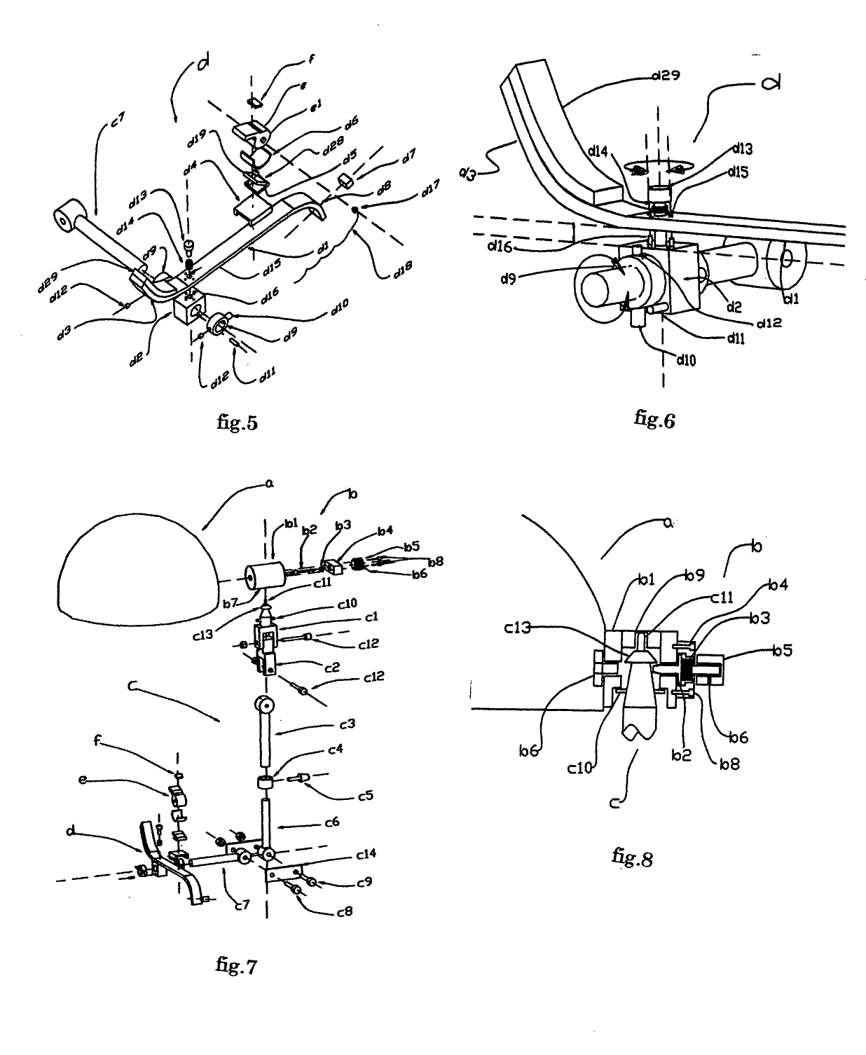

FIG. 5 is a detailed enlarged view of the lever apparatus (d). The means for adjusting an angle of the loading object (d5) has a rocking member (d19), an angle adjusting fulcrum (d30), and an angle adjustment key (d19). The angle adjusting fulcrum (d30) is connected on the means for reciprocating means (d4). The rocking member (d19) is connected with the angle adjusting fulcrum (d30) possible [a swing.]

The loading object holder (d6) is connected to the rocking member (d19). Therefore, the loading object (e) is rocked together with the rocking member (d19). The swing means of the lever part (d) has the arm tip stick (d7), the fulcrum member (d2), and two fulcrum member stop rings (d9).

The arm tip stick (c7) is inserted in the insertion opening provided in the fulcrum member side. Therefore, the fulcrum member (d2) is rotatable connected with the arm tip stick (c7). The two fulcrum member stop rings (d9) lock up on both sides of the fulcrum member (d2) on the arm tip stick (c7). The fulcrum member stop ring (d9) is being fixed to the arm tip stick (c7) by the ring fixed screw (d12).

FIG. 6 is an enlarged detail view near the fulcrum member (d2). The one fulcrum member stop rings (d9) have a lever part maintenance pin (d10) within the two fulcrum member stop rings 1 (d9). The lever part maintenance pin (d10) collides with the lever maintenance pin 2 (d11) attached in the side wall of the fulcrum member (d2). Thereby, the angle of the lever apparatus (d) is held. If the ring fixed screw (d12) is loosened, the angle of the lever apparatus (d) can be adjusted. The means for rotating the link member has a link member axis of rotation (d13). The link member axis of rotation (d13) rotatably connects the link member (d1) on the fulcrum member (d2).

The means for locking the link member has two link members lock pins (d16), four link member lock holes (d15), and springs (d14). The two link member lock pins (d16) are attached on the fulcrum member (d2). The two link member lock pins (d16) are arranged focusing on the link member axis of rotation (d1) undersurface. The four link member lock holes (d15)—the link member axis of rotation (d13) at the diagonal. The four link member lock holed (d15) are attached in the link member (d1) undersurface. The four kink member lick holes (d15)—the link member axis of rotation (d13)—an angle equal as a center-arrangement-now, it is. The link member lock pin (d16) and the link member lock hole (d15) fit in mutually. The spring (d14) is attached between the link member axis of rotation (d13) and the link member (d1). The spring (d14) pushes the link member (d1) from a top. Therefore, if the link member (d1) is raised, it can rotate. When a hand lifted the link member (d1), the link member (d1) is pushed on the spring (d14), and is locked.

FIG. 7 is the whole the putting apparatus (a, b, c, d, e) exploded view.

FIG. 8 is a longitudinal sectional view of the arm connecting means (b). The arm connecting means (b) has a projection (b1), a projection connection bolt (b8), a lid case (d4), a lid case bolt (d8), a knob (d5), a movable pin (b2), a spring (b3), a knob adjustable screw (b6), the arm projection (c13), and a shake prevention pin (c10). The projection (b1) is connected to the hard hat (a) side wall by the projection connection bolt (b8). If the projection connection bolt (b8) is loosened, the projection (b1) can be rotated. A projection (c13) and the movable pin (b2) of the arm (c) fit in each other. The movable pin (b2) has connected with the knob (b5). It is letting the spring (d3) pass to the movable pin (b2). And the spring (b3) is settled into the lid case (b4). Therefore, after the movable pin (b2) is pushed on the projection (c13) of the arm and withdraws, it gets into the hollow of a projection (c13) of the arm. The shake prevention pin (c10) gets into the slot formed in the projection (b1). Therefore, the small shake of the arm (c) can be prevented. A connector terminal (c11) fit into a socket (d9). Therefore, the electric signal detected by the primary detecting element material (f) can be told.

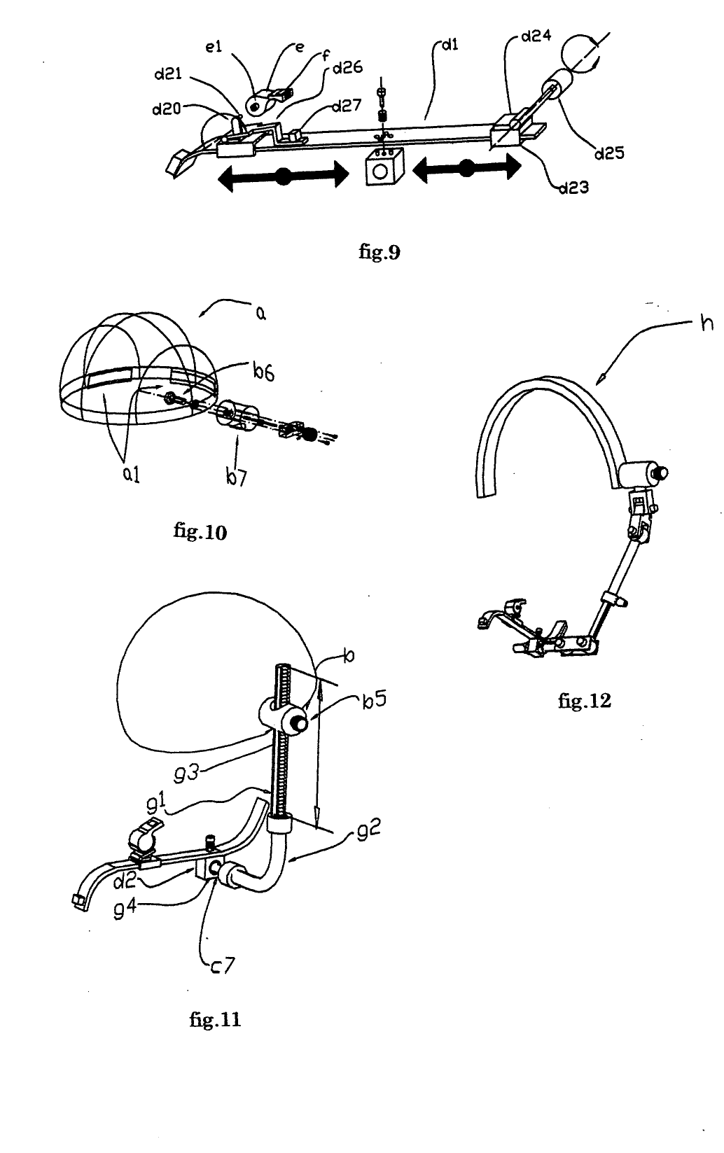

FIG. 9 is other embodiments of the lever apparatus (d). Other embodiments of the lever apparatus (d) have a connector type pin holder (d20), weight (d27), a jaw receptacle holder slide part (d23), a jaw receptacle holder angle adjusting part (d24), and a jaw receptacle holder roller (d25). The connector type pin holder (d20) has a connector terminal (d21) and a connector socket (e1). The connector type pin holder (d20) and the connector socket (e1) are made from the material which conducts electricity. The connector type pin holder (d20) and the connector socket (e1) fit in with each other. Therefore, the electric signal detected by the primary detecting element material (f) can be told. Of course, a detachable attachment and angle adjustment are easily possible. The weight (d27) is attached on the rocking member (d26). Therefore, the rocking member (d26) does not move freely by a shock. The jaw receptacle holder slide part (d23) can move reciprocate to the way of a straight side of the link member (d1). A jaw receptacle holder angle adjusting part (d24) can rock. The jaw receptacle holder roller (d25) rotates, and reduces friction with a jaw.

FIG. 10 is the exploded perspective view of the hard hat (a) and the arm connecting means (b). The hard hat (a) has balance stable weight (a1). The balance stable weight (a1) is the weight for balancing the whole the putting apparatus (a, b, c, d, e). The balance stable weight (a1) is attached in the direction where the rear inside the hard hat (a) and the putting apparatus (b, c, d, e) are not attached in proper quantity.

FIG. 11 is other embodiments of the arm connecting means (b). Other embodiments of the arm connecting means (b) have an arm attaching means with an arm slide stick (g1), a flexible stem (g2), a concavity and convexity (g3), a bearing (g4), and the penetrated arm insertion hole. The concavity and convexity (g3) fits in each other with the movable pin (b2). Therefore, if the knob (d5) is pulled, the arm slide stick (g1) can slide up and down.

FIG. 12 is a head band type the putting apparatus. It may be used putting in the head band into a hat.

It is good to attach a swing delay apparatus in the lever apparatus (d). Although the structure of this swing delay apparatus is already known art, it shows an example below.

1 An apparatus which a lock cancels when lock operation works in a counter direction and the loading object (e) is added, although it turns to a direction on the other hand.

2 An apparatus which the electromagnet goes out when the detector (f) was attached in the jaw receptacle holder (d3) and the loading object (e), an electromagnet operates, a motion of the lever apparatus (d) is stopped when the jaw separated from the jaw receptacle holder (d3), and a mouth adds the loading object (e), or becomes an opposite pole.

The main uses of this apparatus are shown below.

Traffic guidance member is in the state which added the loading object (whistle) (e) to the mouth brandishes a guidance stick and uses a walkie-talkie by control by the primary detecting element material (f).

When a person with trouble in two hands operates an electric wheelchair and a personal computer, a distribution power board is attached in the putting apparatus (e), and it is operated with a tongue.

It cannot be overemphasized in this invention that modifications various otherwise are possible. Therefore, all the modifications that exist in the true soul of this invention and within the limits are included in a claim.

1. An apparatus for putting a loading object in mouth by movement of jaw comprising a headgear, an arm having a means for adjusting the arm length and a means for bending the arm and a means for connecting one end of the arm to the headgear side wall and a lever apparatus connecting to the other end of the arm, the lever apparatus having a fulcrum member and a link member connecting on the fulcrum and a jaw receptacle holder being one end of the link member and a lording object adjustment device being the other end of the link member, a loading object for putting in mouth being connected on the adjustment device, whereby the lording object adjustment device adjusts the status of the loading object relate to mouth of user, and characterized by having a means for swingablly connecting the lever apparatus to the other end of the arm by movement of jaw in contact with the jaw receptacle holder.

2. A putting apparatus according to claim 1, in which the loading object adjustment device includes a means for reciprocating the loading object in the way of a straight side of the link member.

3. A putting apparatus according to claim 1, in which the loading object adjustment device includes a means for adjusting an angle of the loading object by a rocking member connecting the loading object to an angle adjusting fulcrum on the reciprocating means.

4. A putting apparatus according to claim 1, in which the means for swingy movement of the lever apparatus includes a insertion opening on the side of the angle adjusting fulcrum to insertion the other end of the arm.

5. A putting apparatus according to claim 1, in which the means for adjusting the arm length includes a slide device having a structure to expand and contract the arm.

6. A putting apparatus according to claim 1, in which the means for bending the arm includes at least one articulation.

7. A putting apparatus according to claim 1, in which the means for connecting one end of the arm to the headgear side wall includes a recess on the end of the arm, a projection attached to the headgear side wall and a insertion hole provided in the projection and a movable pin in the insertion hole moving in response to the movement of a knob of the projection and a spring pushing the movable pin on the recess.

8. A putting apparatus according to claim 1, in which the lever apparatus includes a loading object holder made of elastic material on the loading object adjustment device that allows detachable attachment of the loading object to the lever apparatus.

9. A putting apparatus according to claim 1, in which the lever apparatus includes a means or rotating the link member on the fulcrum and a means for locking the link member.

10. A putting apparatus according to claim 1, in which the headgear is a hard hat.

11. A putting apparatus according to claim 1, in which the headgear is a head band.

12. A putting apparatus according to claim 1, in which the loading object is a whistle.

13. A putting apparatus according to claim 1, in which the loading object is a detecting element.

14. A putting apparatus according to claim 1, in which the means for bending the arm is a flexible stem.

15. A putting apparatus according to claim 1, in which the second means for connecting one end of the arm to the headgear side wall includes at least one continuously formed recesses placed on side of the arm downward from the end of the arm, the projection attached to the headgear side wall having a through-insertion-hole provided in the projection and the movable pin in the insertion hole moving in response to the movement of knob on the projection and the spring pushing the movable pin on the recess.

16. A putting apparatus according to claim 1, in which the jaw receptacle holder is formed by one end of the link member curved upward.

17. A putting apparatus according to claim 1, in which the jaw receptacle holder includes a jaw putt made from a soft material.

18. A putting apparatus according to claim 1, in which the jaw receptacle holder includes a jaw receptacle holder slide device sliding on the link member to adjust the position of the jaw receptacle holder for jaw.

19. A putting apparatus according to claim 1, in which the jaw receptacle holder includes an angle adjustment for adjusting the angle of the jaw receptacle holder.

20. A putting apparatus according to claim 1, in which the means for swingy movement of the lever apparatus includes a means for temporarily delaying the swing movement when the loading object begins to turn down.
